(19) United States
(12) Patent Application Publication
(10) Pub. No.: US 2026/0075398 A1
(43) Pub. Date: Mar. 12, 2026

(54) ANALYTICS ENHANCED DISCOVERY

(71) Applicant: CONVIDA WIRELESS, LLC, Wilmington, DE (US)

(72) Inventors: Lu LIU, Conshohocken, PA (US); Dale SEED, Allentown, PA (US); Quang LY, North Wales, PA (US); Catalina MLADIN, Hatboro, PA (US)

(73) Assignee: InterDigital Patent Holdings, Inc., Wilmington, DE (US)

(21) Appl. No.: 19/101,985

(22) PCT Filed: Aug. 11, 2023
(86) PCT No.: PCT/US2023/072088

§ 371 Date: Feb. 7, 2025

Related U.S. Application Data
(60) Provisional application No. 63/371,276, filed on Aug. 12, 2022.

(51) Int. Cl. H04W 8/00; H04L 41/14

(52) U.S. Cl. CPC H04W 8/005; H04L 41/14

(57) ABSTRACT

Provided herein are methods for enhancing the existing discovery procedure by leveraging data analytics in the application and service enablement layer. For example, a method may comprise receiving, by an edge enabler server and from a user device, a first message indicating a discovery request for one or more discovery targets, sending, to an analytics service, a second message indicating a request for analytics information associated with the one or more discovery targets, wherein the analytics information comprises prediction information associated with a future status of the one or more discovery targets, receiving, from the analytics service, a third message comprising the analytics information associated with the one or more discovery targets, sending, to the user device and in response to the first message, a fourth message comprising a filtered list of discovery targets based on the analytics information associated with the one or more discovery targets.

### CROSS-REFERENCED TO RELATED APPLICATIONS

This application claims the benefit of, and incorporates herein by reference, U.S. Provisional Application No. 63/371,276, titled “Analytics Enhanced Discovery Procedure,” filed Aug. 12, 2022.

### BACKGROUND

Currently in the service enablement layer of many network architectures, discovery procedures are based on matching the filters in discovery requests with the information of the discovery targets. Taking Edge Application Server (EAS) discovery as an example, the discovery is performed by choosing EASs that may satisfy the requirements of the Edge Enabler Client (EEC)/Application Clients (ACs) as indicated in the discovery request. However, the discovery procedure only considers the current information of the EASs and the ACs. Under the dynamic edge environment, such information may change rapidly, and the discovery results may become non-preferable or even non-applicable soon after the connection is established between the AC and the EAS, resulting in sub-optimal communications or even undesired service disruption.

In many cases, there could be more than one target discovered after applying the filters. Either the entity that is requesting the discovery service or the entity providing the discovery service may need to make a decision on which one of the discovered targets should be selected. For example, the EAS discovery request may contain a list of EASs that may satisfy the requirements of the EEC/ACs. Without information of the future status of the EASs and the ACs, the Edge Enabler Server (EES) or the EEC may not be able to identify the optimal choice of EAS.

The 3GPP SA6 Application Data Analytics Enablement Service (ADAES) provides data analytics at application enabler layers on top of the 5GS. In connection with the development of the ADAES, it has been studied how to collect data from the service enablement layer and generate analytics related to the service enablement layer. However, it has not yet been defined how the analytics information may be leveraged by the service enablement layer to optimize operations and procedures, such as EAS discovery, EEL service provisioning, service Application Programming Interface (API) discovery, and/or the like.

The discovery method is usually used for finding proper entities to provide/receive services. The discovery method is performed by matching the filters in the discovery request with the information of the discovery targets based on the current information of relevant entities. Under a dynamic network environment, such information may change rapidly, and the discovery results may become non-preferable or even non-applicable, resulting in sub-optimal service performance or undesired service disruption. Thus, improvements are needed.

### SUMMARY

Disclosed herein are methods and apparatuses for enhancing an existing discovery procedure by leveraging data analytics in the application and service enablement layer. Predictive information may be obtained by utilizing an analytics service, and based on the predictive information, various operations may be applied to enhance the discovery procedure. Particularly, the disclosed methods may enhance EAS discovery, Edge Enabler Layer (EEL) service provisioning, Common API Framework (CAPIF) service API discovery, and EEL AC information exposure.

A server, such as an edge enabler server, may receive a first message from a user device. The first message may indicate a discovery request for one or more discovery targets. The one or more discovery targets may comprise one or more servers, such as edge application servers. The edge enabler server may send a second message to an analytics service. The second message may indicate a request for analytics information associated with the one or more discovery targets. The analytics information may comprise prediction information associated with a future status of the one or more discovery targets. The edge enabler server may receive a third message from the analytics service. The third message may comprise the analytics information associated with the one or more discovery targets. The edge enabler server may send a fourth message to the user device, in response to the first message. The fourth message may comprise a filtered list of discovery targets based on the analytics information associated with the one or more discovery targets received in the third message.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example EEL Architecture;

FIG. 2 shows an example process for an analytics-enhanced discovery procedure initiated by a DSP;

FIG. 3 shows an example process for an analytics-enhanced discovery procedure initiated by DSR;

FIG. 4 shows another example process for an analytics-enhanced discovery procedure initiated by DSR;

FIG. 5 shows another example process for an analytics-enhanced discovery procedure initiated by DSR;

FIG. 6 shows an example process for an analytics-enhanced EAS discovery procedure initiated by an EES;

FIG. 7 shows an example process for an analytics-enhanced EAS discovery procedure initiated by EEC;

FIG. 8 shows an example GUI for the DSP to configure analytics service for enhanced discovery.

FIG. 9 shows an example GUI for the DSR to request analytics-enhanced discovery service.

FIG. 10A shows an example communications system in which the methods and apparatuses described and claimed herein may be an aspect of;

FIG. 10B shows a block diagram of an example apparatus or device configured for wireless communications;

FIG. 10C shows a system diagram of an example radio access network (RAN) and core network;

FIG. 10D shows a system diagram of another example RAN and core network;

FIG. 10E shows a system diagram of another example RAN and core network;

FIG. 10F shows a block diagram of an example computing system; and

FIG. 10G shows a block diagram of another example communications system.

### DETAILED DESCRIPTION

Methods and apparatuses are described herein for enhancing the existing discovery procedure by leveraging data analytics in the application and service enablement layer. In the following description of these methods and apparatuses, the terms “procedure” and “method” may be used interchangeably.

The following abbreviations may be used herein:
3GPP Third Generation Partnership Project
5GS 5G System
AC Application Client
ACR Application Context Relocation
ADAES Application Data Analytics Enablement Service
AF Application Function
API Application Programming Interface
AS Application Server
ANSP Analytics Service Provider
CAPIF Common API Framework
CN Core Network
DSP Discovery Service Provider
DSR Discovery Service Requestor
EAS Edge Application Server
EDN Edge Data Network
EEC Edge Enabler Client
EEL Edge Enabler Layer
EES Edge Enabler Server
ECS Edge Configuration Server
GUI Graphical User Interface
KPI Key Performance Indicator
NEF Network Exposure Function
Qos Quality of Service
SCEF Service Capability Exposure Function
SEAL Service Enabler Architecture Layer for Verticals
UE User Equipment
VAL Vertical Application Layer

Generally, the following entities may be involved in an analytics-enhanced discovery method:

Discovery service requestor (DSR): The entity that may request the discovery service (by sending a discovery request or discovery subscription request).

Discovery service provider (DSP): The entity that may provide the discovery service (by sending a discovery response or a discovery notification). The DSP may be pre-configured with information of an analytics service provider.

Analytics service provider (ANSP): The entity that may provide the analytics service, such as an ADAE server.

Discovery targets: The entities that may be discovered and included in the discovery response.

Analytics targets: The entities whose analytics information may be collected and generated for the analytics service. The analytics targets may be the same entities as the discovery targets, and may include the DSR, DSP and/or other entities involved in the discovery procedure.

The following table shows several example discovery procedures in the service enablement layer, with the corresponding DSR, DSP, discovery targets and analytics targets:

| | | | Discovery | |
|---|---|---|---|---|
| Procedure | DSR | DSP | targets | Analytics targets |
| EAS discovery | EEC | EES | EAS | EAS, EEC, AC, UE |
| Service | EEC | ECS | EES and/or | EES, EDN, EEC, |
| provisioning | | | EDN | AC, UE |
| (EEL) | | | | |
| Service API | API | CAPIF | Service API | Service API, API |
| discovery | invoker | core | | invoker, CAPIF |
| (CAPIF) | | function | | Core Function, API |
| | | | | Exposing Function, |
| | | | | API Publishing |
| | | | | Function |
| AC information | EAS | EES | AC | AC, EEC, UE, EAS |
| exposure | | | | |

The entities detailed in table above (DSR. DSP, and/or the like) are provided as example but other implementations of other entities are also be envisioned. Similarly, other aspects of the methods and apparatuses disclosed may be used with methods and apparatuses different than those provided in the table or otherwise disclosed herein.

In the application and service enablement layer, a discovery procedure may be used for finding proper entities to provide and/or receive services. The discovery procedure may be performed by matching the filters in the discovery request with the information of the discovery targets based on the current information of relevant entities. Under a dynamic network environment, such information may change rapidly, and the discovery results may become non-preferable or even non-applicable, resulting in sub-optimal service performance or undesired service disruption. The methods and apparatuses for enhancing the existing discovery procedure disclosed herein may leverage data analytics in the application and service enablement layer by utilizing predictive information obtained from an analytics service, based on which various operations may be applied to enhance the discovery procedure.

For example, an analytics service provider may generate analytics results and/or predictive information as required in a configuration request, such as predicting the status or load of analytics targets, predicting the occurrence of an event associated with one or more of the analytics targets, generating a ranking list of the analytics targets according to the predictive information in terms of availability, performance, reliability, and/or generating recommendations on selecting one or more analytics targets according to the predictive information in terms of availability, performance, reliability, and/or the like.

The analytics service provider may also report the generated analytics results. The results may be reported to the discovery service provider or requestor, immediately after it is generated, or reported according to a schedule as configured in the configuration request, or reported when a triggering event is detected, or reported when a retrieval request is received from the requestor. The analytics service provider may also receive a notification that the generated analytics results have been applied in a discovery procedure.

In accordance with the methods and apparatuses disclosed herein, a discovery service provider (EES, ECS, CAPIF core function), may send an analytics service configuration request to an analytics service provider for predictive information of one or more analytics targets. The analytics service configuration request may specify the analytics target(s) and what analytics results are required (predictive event detection, recommendation, ranking, and/or the like). The analytics service configuration request may also specify the reporting target(s) (identifiers and/or contact information) and how to report the results (schedule of reporting, event-triggered reporting, hold until retrieval, and/or the like).

The discovery service provider may also receive a discovery request from a discovery service requestor. The discovery service provider may also identify an initial list of discovery targets based on the filter defined/indicated in the discovery request, and then may send a retrieval request to the analytics service provider to retrieve analytics results associated with the discovery targets in the initial list.

The discovery service provider may also receive analytics results/predictive information from the analytics service provider. The analytics results may be received before or after receiving the discovery request and/or may be received as a response to a retrieval request.

The discovery service provider may also update the list of discovery targets based on the received analytics results and generate a discovery response with the updated list. The discovery service provider may then select and/or remove one or more discovery targets from the initial list based on the predictive information and/or recommendation. The discovery service provider may then send the discovery response to the discovery service requestor and/or send a notification to the analytics service provider, informing the latter if/what analytics results have been applied in a discovery procedure.

Further in accordance with the methods and apparatuses disclosed herein, a discovery service requestor may send a discovery request to a discovery service provider. The discovery request may indicate an analytics service request for predictive information of one or more analytics targets. The discovery request may specify what analytics results are required (predictive event detection, recommendation, ranking, and/or the like) and/or may specify the reporting target (identifiers and/or contact information) and how to report the results (schedule of reporting, event-triggered reporting, hold until retrieval, and/or the like).

The discovery service requestor may also receive a discovery response from the discovery service provider. The discovery response may include information indicating whether analytics results have been applied when generating this response. The discovery service requestor may also receive analytics results/predictive information. The analytics results may be received from an analytics service provider or the discovery service provider. The discovery service requestor may also send a notification to the analytics service provider, informing the latter if/what analytics results have been used.

An edge enabler server may comprise one or more processors and memory. The memory may store instructions that, when executed by the one or more processors, may cause the edge enabler server to perform various operations. The edger enabler server may receive from a user device a first message indicating a discovery request for one or more discovery targets. The one or more discovery targets may comprise one or more edge application servers. The user device may comprise a user equipment, a discovery service requestor, or another edger enabler server. The first message may further indicate a request for an analytics enhanced discovery service. The first message may further comprise a request for analytics information associated with the one or more discovery targets.

The edge enabler server may send a second message to an analytics service indicating a request for analytics information associated with the one or more discovery targets. The analytics information may comprise prediction information associated with a future status of the one or more discovery targets.

The edger enabler server may receive a third message from the analytics service comprising the analytics information associated with the one or more discovery targets. The edge enabler server may send a fourth message to the user device in response to the first message. The fourth message may comprise a filtered list of discovery targets based on the analytics information associated with the one or more discovery targets received in the third message. The filtered list may rank the one or more discovery targets based on the prediction information associated with the future status of the one or more discovery targets. The fourth message may comprise at least a portion of the analytics information received in the third message. The fourth message may further comprise a recommendation indicating which one or more discovery targets of the filtered list to select.

A user device may select one or more discovery targets of the one or more discovery targets for a service. The user device may send to the edge enabler server, or the analytics service, another message indicating the one or more discovery targets selected based on the filtered list.

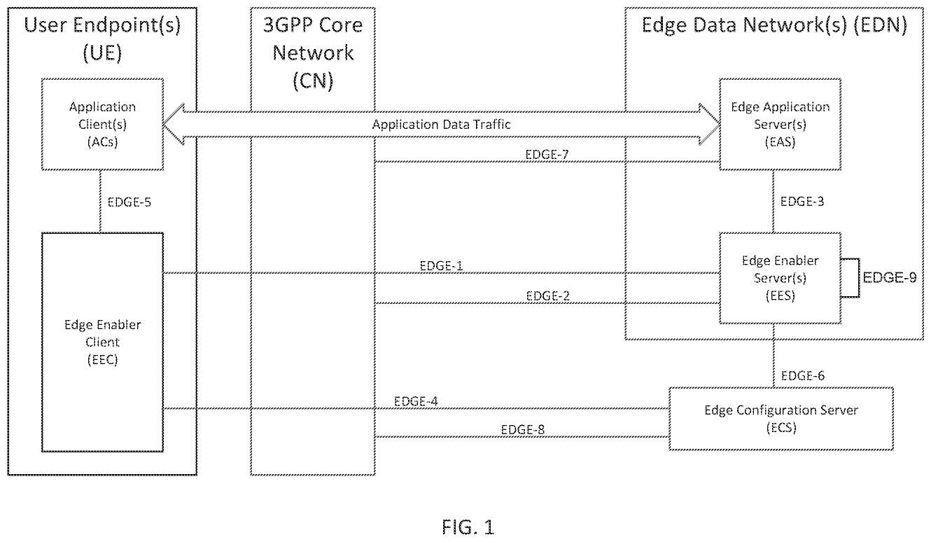

FIG. 1 shows an example Edge Application Enabler Layer (EEL) architecture defined by 3GPP TS 23.558, Architecture for enabling Edge Applications. EEL refers to the overall functionality provided by the entities such as Edge Enabler Clients (EECs), Edge Enabler Servers (EESs) and Edge Configuration Servers (ECSs), necessary for enabling UE Application Clients (ACs) to interact with Edge Application Servers (EASs) over 3GPP networks. For edge computing, it is essential that UE ACs are able to locate and connect with the most suitable EASs available within the EDNs that the UEs are located in. This may be dependent on the needs of the ACs and the availability of EASs in edge data networks. The EEL may support a set of services and exposes these services via APIs defined for each of the EEL defined reference points (e.g., EDGE-1 thru EDGE-9).

Some of the services may include services for discovery of ECSs and provisioning of edge computing services based on a UEs location and service requirements, services for registration of EECs to EESs and EASs to EESs, services for providing continuity or service between ACs and EASs (e.g., when a UE moves from one EDN to another EDN), and/or exposure of 5GC services for use by EASs

EAS discovery may enable entities in an edge deployment to obtain information about EAS and their available services, based on specified criteria of interest. EAS discovery may be initiated by the EEC, which may enable the EEC to obtain information about available EASs of interest. The discovery of the EAS may be based on matching EAS discovery filters provided in the request, including profiles of the ACs for which a matching EAS is needed and list characteristics of required FASs. When multiple EASs are discovered for a specific AC, the EEC may select one or more EASs to enable AC communication with one of the selected EASs.

Service provisioning may allow configuring the EEC with information about available Edge Computing services, based on the hosting UE's location, service requirements, service preferences and connectivity. This configuration may include the necessary address information for the EEC to establish connection with the EES(s). The EEC may send a service provisioning request to the ECS, providing UE location information and AC profiles. In the service provisioning response, the ECS may provide list of EDN configuration information, including EDN connection information and list of EESs of the EDN.

3GPP SA6 Application Data Analytics Enablement Service (ADAES) may provide data analytics at application enabler layers on top of the 5GS. The service may support data collection and analytics for application performance, session performance, service experience, edge load, service API, and/or the like. The analytics that may be supported include, but are not limited to, statistics and predictions of application layer and service enablement layer data. However, those skilled in the art could adapt other services to be included.

The request for analytics service may initiated by the DSP, while the DSR may not be involved in the analytics related procedure. The ANSP may or may not be aware of the DSR associated with the analytics request.

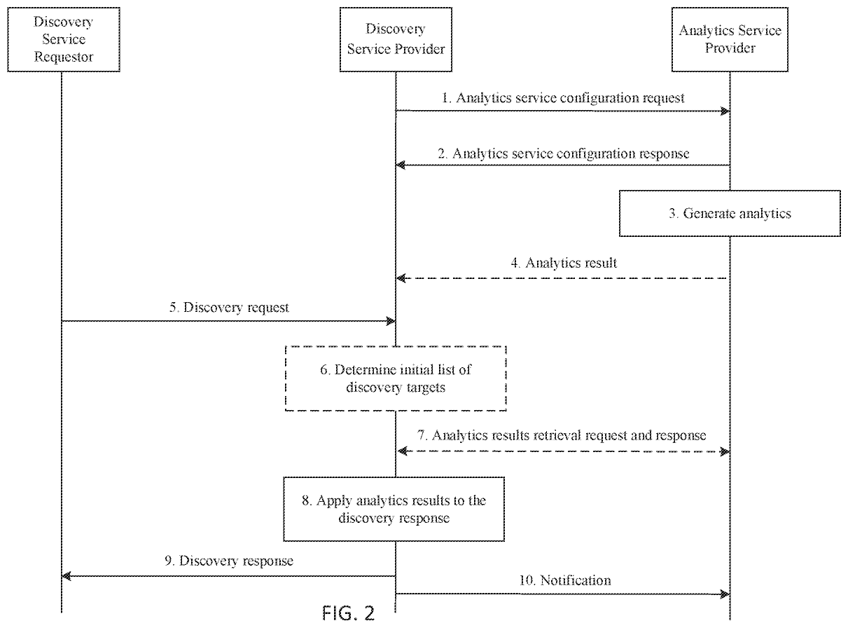

FIG. 2 shows an example method. The method of FIG. 2 may be employed when a request for analytics service is initiated by the DSP, while the DSR may not be involved in the analytics related procedure. The DSP may be pre-configured with information of the ANSP, but the ANSP may or may not be aware of the DSR associated with the analytics request.

As shown in FIG. 2, in step 1, the DSP sends an analytics service configuration request to the ANSP.

In the configuration request, the DSP may specify the analytics target(s), which could be the same as the discovery target for the discovery service. The DSP may also specify what analytics results are required, such as prediction information, event prediction, recommendations, rankings of analytics targets, and/or the like. The ANSP may use information about the analytics targets, such as identifiers and IP address and port number, to obtain data (e.g., mobility) about the analytics targets from the 5GS.

In the configuration request, the DSP may specify how the generated analytics should be reported to the DSP, such as reporting immediately after the analytics are generated, reporting according to a pre-defined schedule, reporting when triggered by a certain event, holding the generated results until retrieved by the DSP, and/or the like.

Optionally, the DSP may add the contact information of the DSR as another reporting target, so that the generated analytics results could be sent to both the DSP and the DSR. This ensures that the analytics information available at the DSR and at the DSP could be the same. When the analytics results are configured to be sent to a DSR, an expiration may be configured to account for DSR mobility, e.g., the DSR leaving the service area.

The DSP may send the analytics service configuration request ahead of providing discovery service or receiving a discovery request as it may take time for the ANSP to generate analytics results and provide to the DSP. Alternatively, the DSP may send the analytics service configuration request after receiving a discovery request.

The DSP may send an update request to provide additional information of analytics targets or change the configuration of analytics service, such as to add/remove analytics targets, changing the reporting method/schedule, adding an expiration for providing analytics results to DSRs, and/or the like.

The DSP may also provide in the request a location/entity where the analytic results should be stored.

The DSP may also provide in the request information about other reporting targets of the analytics results. For example, the DSP may provide filters or criteria for determining additional analytics result receivers, e.g., UEs/EECs in a certain area of interest.

The analytics service configuration request may also be realized as an analytics service subscription request, with the analytics results being provided via notification messages instead.

In step 2 of FIG. 2, the ANSP may send an analytics service configuration response to the DSP. The response may include an identifier for the analytics instance that is created for this request and other information of the instance, such as an expiration for the analytics instance.

In step 3, the ANSP may start to collect data and generate analytics results according to the configuration request. The ANSP may interact with the analytics targets and/or other entities to obtain information of the analytics targets to generate analytics results based on the collected data. Particularly, the ANSP may make predictions on the future status of the analytics targets and/or a future event associated with the analytics targets. The ANSP may further process the analytics to generate results such as recommendations or rankings of the analytics targets (e.g., with respect to their performance, availability, schedule, and/or the like), which may be used by the DSP in the discovery service.

In step 4, the ANSP may report to the DSP with the generated analytics results. After receiving the analytics results, the DSP may send a notification to the DSR with information about the analytics that it has available to use in discovery.

In step 5, the DSP may receive a discovery request from the DSR. The request may be either a one-time discovery request or a subscription request. For a subscription request, step 6 to 8 could be repeated for each response/notification.

In step 6, if the DSP has already received analytics results which are enough for generating the discovery response, then step 6 and 7 may be skipped. Otherwise, the DSP may determine an initial list of discovery targets by applying the discovery filters included in the discovery request (same as the discovery procedure without analytics).

In step 7, if the DSP has not yet received analytics results or the analytics results locally available at the DSP are outdated/insufficient, the DSP may request or retrieve analytics results from the ANSP. In the retrieval request, the DSP may specify that only the analytics results associated with the analytics/discovery targets in the initial list (determined in step 6) are required. The DSP may also configure the DSR as new analytics targets and to receive analytics results.

In step 8, the DSP may apply the analytics results (either locally available or retrieved from the ANSP in step 7) to generate the discovery response. For example, the DSP may exclude one or more discovery targets (e.g., with relatively lower expected reliability, predicted overload/unavailability) from the discovery response based on the analytics results. If the DSP has requested recommendation or ranking information from the ANSP, the DSP may choose the recommended target(s) or the targets with higher ranking to be included in the discovery response.

In step 9, the DSP may send the discovery response generated in step 8 to the DSR. In the response, the DSP may include an indicator that analytics service has be utilized and/or analytics results have been applied when generating the response. Upon receiving the discovery response, the DSR may select one or more discovery targets and notify the DSP of the selected discovery target(s).

In step 10, the DSP may send a notification to the ANSP, informing the ANSP what/how analytics results have been applied in a discovery procedure. For example, the DSP may indicate that one or more analytics targets have been included in a discovery response or excluded from a discovery response. The DSR may send a notification to the ANSP, informing the ANSP what/how analytics results have been used by the DSR. For example, the DSR may indicate that one or more analytics targets have been selected by the DSR to provide service.

The DSR may initiate an analytics service request, which may be either sent directly to the ANSP or implied in a discovery request. The following options are available and may be chosen by the DSR based on its preference or limitation.

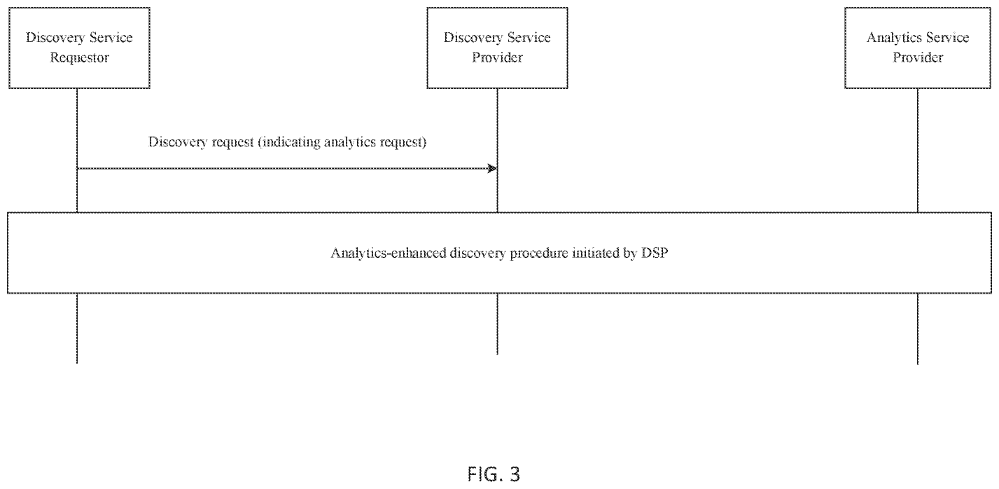

For Option 1, as shown in FIG. 3, the DSR may indicate the need for analytics service in the discovery (subscription) request, while the rest of the procedure is the same as the DSP-initiated procedure. The DSR may specify information and requirements of the analytics service that will be later incorporated in the analytics service configuration request. Alternatively, the DSR may specify one or more filter/notification criteria in the discovery request implying the need for analytics service, such as expected performance or availability, predicted event or condition, preferred ranking, and/or the like. In this option, the DSR may receive the discovery response that has been processed based on the analytics results and does not need to directly interact with the ANSP. This option may best suit the scenario where the DSR may not have access to the ANSP, or the DSR is hosted on a constrained device.

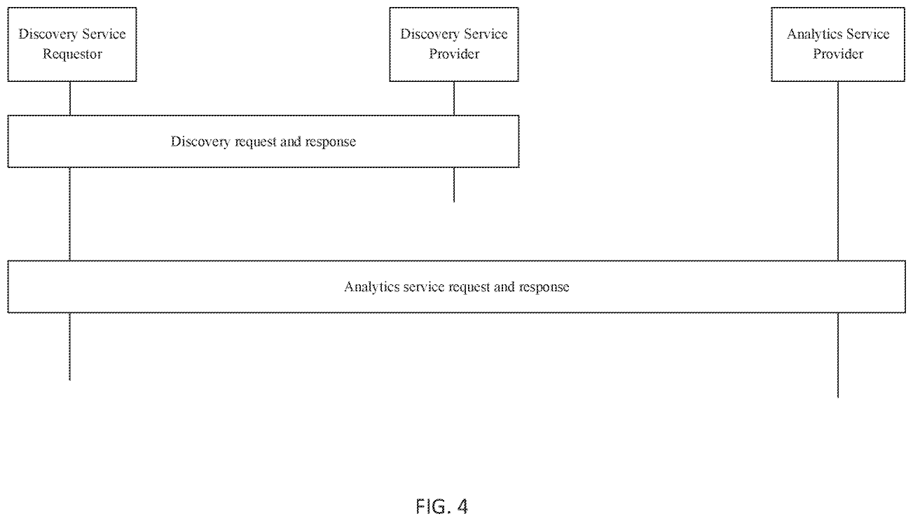

For Option 2, as shown in FIG. 4, the DSR may directly request an analytics service from the ANSP. The analytics request may be sent following a normal discovery (subscription) procedure. After receiving a discovery response/notification, the DSR may request analytics information of the discovered targets directly from the ANSP (e.g., by setting the discovered targets as analytics targets). The DSR may have discovered or be pre-provisioned with information of the ANSP. The DSR may have discovered ANSPs from the DSP, which included ANSP contact information in the discovery response. This option may best suit the scenario where the DSR may not have persistent connection with the DSP, or the DSR would like to directly access the analytics information and/or apply the analytics results.

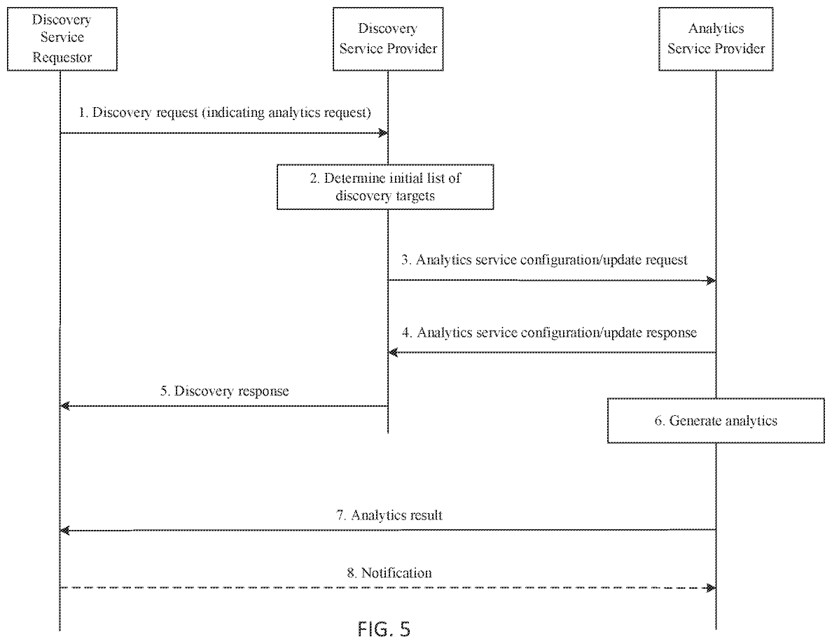

For Option 3, as shown in FIG. 5, the DSR may require the analytics results to be reported to the DSR without sending a direct request to the ANSP. The DSP may forward the request and the information of the DSR to the ANSP so that the ANSP will be able to report directly to the DSR after generating analytics results. Option 3 may be applicable to the scenario where the DSR does not have an initial connection to the ANSP and would leverage the help of a DSP to get access to the analytics service. This option may also apply to the scenario where the DSR would like to directly access the analytics information and/or apply the analytics result and would also want the DSP to get involved in the analytics procedure.

In aspects similar to Option 3, the DSR may be aware the DSP has been pre-configured with information of an ANSP (e.g., the DSP may have exposed to the DSR its capability of supporting analytics service). The following are the steps of Option 3, as shown in FIG. 5.

In step 1, the DSR may send a discovery (subscription) request to the DSP. In the request, the DSR may indicate the need for analytics service, such as predicted information of the discovery targets, recommendations on the discovery targets, and/or the like. The DSR may specify some or all the configuration information needed in the analytics service configuration request. Alternatively, or additionally, the DSR may specify one or more filter/notification criteria in the discovery (subscription) request implying the need for analytics service, such as expected performance or availability, predicated event or condition, preferred ranking, and/or the like. (similar to the configuration information in step 1 of FIG. 2).

The DSR may specify any requirements or preference on the ANSP in the discovery (subscription) request. The DSR may also indicate in the request that any analytics results generated for this request should also be reported to the DSP (or another reporting target).

In step 2, the DSP may determine an initial list of discovery targets by applying the discovery filters included in the discovery request.

In step 3, the DSP may send an analytics service configuration request to the ANSP. The request includes requirements indicated by the DSR in the discovery request, where the DSP may translate information in the discovery request to requirements for analytics services. In the configuration request, the DSP may also include the contact information of the DSR. For example, the DSP may specify the reporting target as the DSR or the UE associated with the DSR. The contact information of the DSR may be used by the ANSP to directly send analytics results to the DSR and to obtain information (e.g., mobility) about the DSR from the 5GS.

The DSP may also add itself as a reporting target (spontaneously or as requested by the DSR), so that the generated analytics results could be sent to both the DSP and the DSR. This ensures that the analytics information available at the DSR and at the DSP may be synchronized.

The DSP may have already configured the analytics service before this step, e.g., through the DSP-initiated procedure (as shown in FIG. 2) or when receiving a discovery request from another DSR. In this case, the DSP may send an update request to the ANSP to update the configuration of analytics service by adding the new requirements from the DSR.

In step 4, the ANSP may send a response to the DSP. The response may include an identifier of the analytics instance associated with this analytics request and other information of the instance, such as an expiration for the analytics instance. The analytics instance identifier may be later used by the DSR to associate analytics results received from the ANSP with the discovery request.

In step 5, the DSP sends a discovery response/notification to the DSR, including the analytics instance identifier received in step 4. Optionally, the DSP may apply analytics results to the discovery response before sending it to the DSR (similar to step 8 and 9 of FIG. 2). The DSP may indicate in the response whether analytics results have been applied.

In step 6, the ANSP may start to collect data and generate analytics according to the (updated) configuration request.

In step 7, according to the reporting target configured in step 3, the ANSP may send the analytics results to the DSR (and to the DSP, if applicable).

In step 8, the DSR may send a notification to the ANSP, informing the ANSP what/how analytics results have been used by the DSR. For example, the DSR may indicate that one or more analytics targets have been selected by the DSR to provide service.

An analytics-enhanced discovery procedure may be applied to EAS discovery procedure in EEL. For analytics enhanced EAS discovery, the EEC may be the DSR, while the EES may be the DSP. The analytics service could be provided by ADAES, where the corresponding ADAE server may be co-located with the EES or in the core network, and the corresponding ADAE client may be co-located with the EEC (on the same UE).

The following procedure may also apply to EEC registration procedures if EAS discovery and/or selection information is included in the registration procedure.

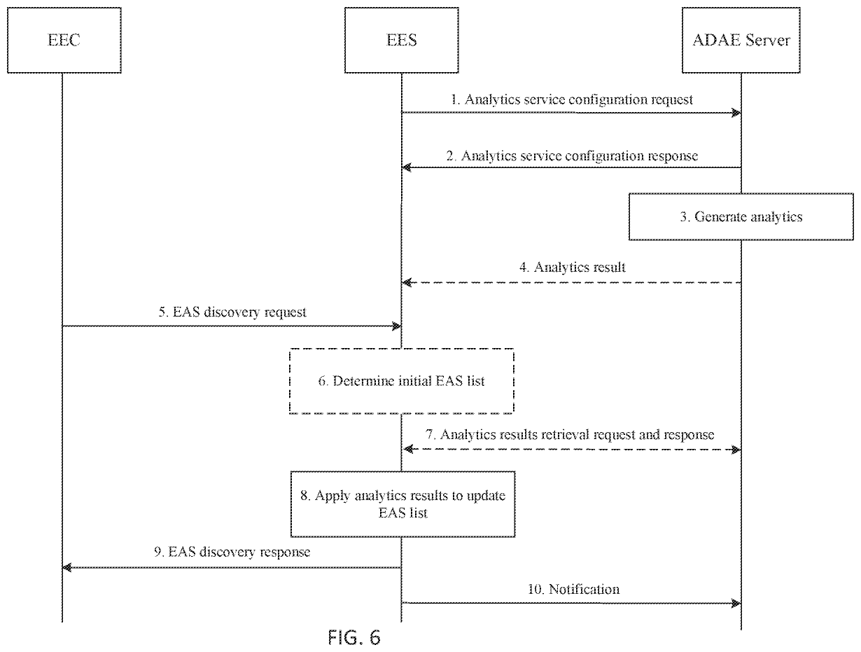

FIG. 6 shows an example method. The method of FIG. 6 may be employed when the request for analytics service is initiated by the EES. The EEC may not be involved in the analytics related procedure, and the ADAE server may not be aware of the EEC associated with the analytics requests. In the following steps, the EES may be pre-configured with information of the ADAE server (e.g., by the ECS).

As show in FIG. 6, in step 1, an EES may send an analytics service configuration (subscription) request to the ADAE server. In the configuration request, the EES may specify what analytics results may be required. The following non-exhaustive list of types of analytics may be requested by the EES to enhance the EAS discovery procedure: Predictive EAS status information (e.g., load, availability, number of serving sessions, reliability, and/or the like); Prediction of whether the EEC/UE will be in or out of the service area of an EAS after a certain amount of time. The EES may specify the length of the time window; Prediction of services needed from the EASs or users' demand (by ACs/users in the same area as the requesting EEC); Prediction of possible AC associations (ACs that are being served by the same EAS) based on predicted location, or based on prediction of services needed by ACs/user from the EASs; Predicted/expected EAS event (e.g., EAS load exceeding a pre-defined threshold, EAS maintenance); EAS ranking (in terms of availability, idle resources, reliability, and/or the like); and recommended EAS or EAS list (in terms of availability, idle resources, reliability, and/or the like).

If the requested analytics require information of an entity other than EASs (such as the EEC/AC/user), the EES may send an update request to the ADAE server once the information is available (e.g., after receiving a discovery request from the EEC). The ADAE server may use information of these entities (EAS, EEC, AC, user) to obtain data from the 5GS.

The EES may provide in the request information about the reporting targets of the analytics results. When the analytics results are configured to be sent to an EEC, an expiration may be configured to account for the mobility of the EEC/UE, e.g., EEC leaving the service area. For example, the EES may provide filters or criteria for determining additional analytics result receivers, e.g., UEs/EECs in a certain area of interest.

The EES may initiate the configuration request when it is deployed to the EEL and has discovered the ADAE server, or after the first EAS is deployed/instantiated/registered at this EES. The EES may send an analytics service update request when a new EAS is instantiated at the EES by adding the new EAS to the existing analytics targets.

In step 2, the ADAE server may send an analytics service configuration response to the EES. The response may include an identifier for the analytics instance that is created for this request and other information of the instance, such as an expiration for the analytics instance.

In step 3, the ADAE server may start to collect data and generate analytics results according to the configuration request. The ADAE server may interact with the EES, the EASs indicated in the configuration request, and/or other entities to obtain information of the EASs and the EEL to generate analytics results based on the collected data.

In step 4, the ADAE server may report to the EES with the generated analytics results. After receiving the analytics results, the EES may send a notification to the EEC with information about the analytics that it has available to use in discovery.

In step 5, the EES may receive an EAS discovery (subscription) request from the EEC. For a subscription request, step 6 to 8 may be repeated for each discovery notification.

In step 6, if the EES has already received analytics results which are enough for generating the discovery response, then step 6 and 7 may be skipped. Otherwise, the EES may determine an initial list of EASs by applying the discovery filters included in the EAS discovery request (same as the EAS discovery procedure without analytics).

In step 7, if the EES has not yet received analytics results or the analytics results locally available are outdated/insufficient, the EES may retrieve analytics results from the ADAE server. In the retrieval request, the EES may specify that only the analytics results associated with the EASs in the initial list (determined in step 6) are required. The EES may also configure the EEC as new analytics targets and to receive analytics results.

In step 8, the EES may apply the analytics results to determine the EAS list and generate the discovery response. Depending on what may be requested in the configuration request, the following operations may be applied when generating the discovery response: Based on the predictive EAS status information (e.g., load, availability, number of serving sessions, reliability, and/or the like), the FES may select the FASs with better predicted performance (e.g., lower load, higher reliability) as the discovered EASs; The EES may exclude an EAS from the discovery response if the EEC/UE is predicted to be soon out of the EAS's service area; If the AC(s) associated with the EES is predicted to be in a possible AC association, the EES may select the (predicted) common EAS(s) for that AC association as the discovered EAS(s); Based on the predicted/expected EAS event, the EES may exclude an EAS that is predicted to be overloading or offline/unavailable from the discovery response; If EAS ranking is provided by the ADAE server, the EES may include highly ranked EASs in the discovery response, and/or include the ranking information in the response; and if EAS recommendation is provided by the ADAE server, the EES may include the Recommended EAS or EAS list in the discovery response.

In step 9, the EES may send the discovery response generated in step 8 to the EEC. In the discovery response, the EES may also include analytics information related to the discovered EASs. Upon receiving the discovery response, the EEC may select one or more EASs and notify the EES of the selected EAS(s).

In step 10, the EES may send a notification to the ADAE server, informing the ADAE server what/how analytics results have been applied in a discovery procedure. For example, the EES may indicate that one or more EASs have been included in a discovery response or excluded from a discovery response.

In the EEC-initiated procedure, the EEC may initiate an analytics service request. The following is a non-exhaustive list of configuration options.

For example, in Option 1, which may be similar to FIG. 3, the EEC may indicate the need for analytics service in the discovery (subscription) request, while the rest of the procedure is the same as the EES-initiated procedure (as shown in FIG. 6). In this option, the EEC may receive discovery response that has been processed based on the analytics results, and may not need to directly interact with the ADAE server/client. This option may apply to the scenario where the EEC may not have access to the ADAE server, or the EEC is hosted on a constrained device.

Additionally, in Option 2, which may be similar to FIG. 4, the EEC may directly request analytics service from the ADAE server/client. The analytics request may be sent following a normal EAS discovery (subscription) procedure, and the discovered EAS list will be set as the analytics targets in the analytics request. The EEC may have discovered or be pre-provisioned with information of the ADAE server/client. The EEC may have discovered the ADAE server from the EES, which included ADAE server contact information in the discovery response. This option may apply to the scenario where the EEC may not have persistent connection with the EES (e.g., due to mobility), or the EEC would like to directly access the analytics information and/or apply the analytics results (e.g., make the decision of selecting EAS).

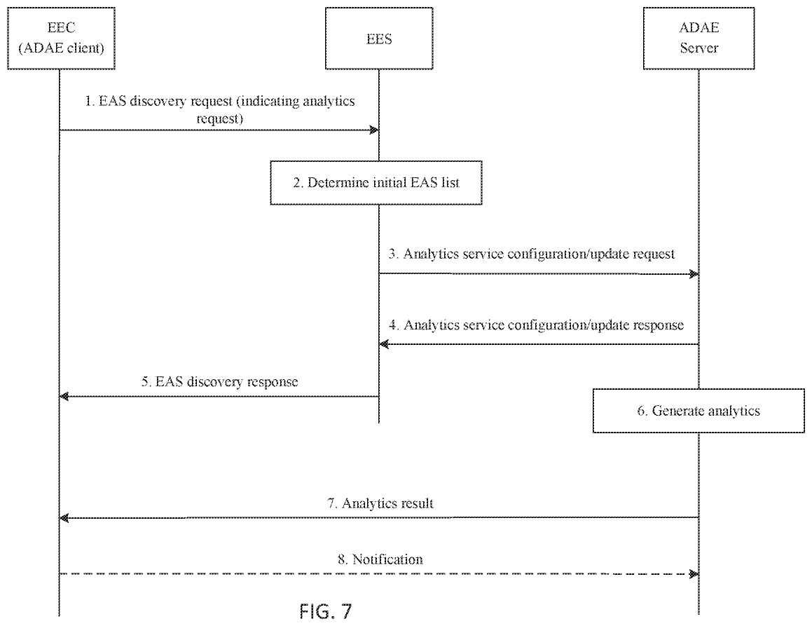

Lastly, in Option 3, which may be shown in FIG. 7, the EEC may require the analytics results to be reported to the EEC without sending a direct request to the ADAE server and the EEC may be aware that the EES has been pre-configured with information of the ADAE server (e.g., the EES may have exposed to the EEC its capability of supporting analytics service). The following steps show an example of this option, as depicted in FIG. 7.

In step 1, the EEC may send an EAS discovery (subscription) request to the EES. In the request, the EEC may indicate the need for EAS-related analytics, such as predicted information of the discovered EASs, recommended EAS, predicted AC associations based on predicted location or prediction of services needed by the ACs, and/or the like. The EEC may specify one or more filter/notification criteria implying the need for analytics service, such as expected schedule or EAS, expected EAS performance or availability, predicted event or condition, preferred ranking of EAS in terms of performance/reliability, and/or the like. (similar to the configuration information in step 1 of FIG. 6).

The EEC may specify any requirements or preference on the ADAE server in the discovery (subscription) request. For example, the EEC may request EDN-specific analytics so that the ADAE server linked to the EDN could be chosen to provide the required analytics service. The EEC may indicate in the request that the analytics results generated for this request should also be reported to the corresponding EES or specify another reporting target (e.g., another EES to which the EEC will be switching to).

In step 2, the EES may determine an initial EAS list by applying discovery filters included in the EAS discovery request.

In step 3, the EES may send an analytics service configuration request to the ADAE server. The request may include requirements indicated by the EEC in the discovery request, where the EES may translate information in the discovery request to requirements for analytics services. In the configuration request, the FES may also include the contact information of the EEC, which may be used by the ADAE server to directly send analytics results to the EEC and to obtain information (e.g., mobility) of the EEC/UE from the 5GS. For example, the EES may specify the reporting target as the EEC or the UE associated with the EEC.

The EES may also add itself as a reporting target (spontaneously or as requested by the EEC), so that the analytics information available at the EEC and the EES could be synchronized.

The EES may have already configured the analytics service before this step, e.g., through the EES-initiated procedure (as shown in FIG. 6) or when receiving a discovery request from another EEC. In this case, the EES may send an update request to the ADAE server to update the configuration of analytics service by adding the new requirements from the EEC.

In step 4, the ADAE server may send a response to the EES. The response may include an identifier of the analytics instance associated with this analytics request and other information of the instance, such as an expiration for the analytics instance.

In step 5, the EES may send a discovery response/notification to the EEC, including the analytics instance identifier received in step 4. Optionally, the EES may apply analytics results to the discovery response before sending it to the EEC (similar to step 8 and 9 of FIG. 6).

In step 6, the ADAE server may start to collect data and generate analytics according to the (updated) configuration request.

In step 7, according to the reporting target configured in step 3, the ADAE server may send the analytics result to the EEC (and to the EES, if applicable). The ADAE server may first identify the ADAE client hosted on the same UE as the target EEC and sends the results to the ADAE client, which may then forward the results to the EEC.

In step 8, the EEC may send a notification to the ADAE server (via the ADAE client), informing the ADAE server what/how analytics results have been used by the EEC. For example, the EEC may indicate that one or more EASs have been selected by the EEC.

The method as outlined in the DSP-initiated and DSR-initiated analytics service requests, as shown in FIGS. 2 and 3 respectively, may be applied to an EEL service provisioning method. As indicated in the previous table, the DSR may be the EEC and the DSP may be the ECS. In analytics-enhanced service provisioning procedure, the following non-exhaustive list of types of analytics may be requested by the ECS/EEC: Predictive EDN/EES status information (e.g., load, availability, number of serving sessions, reliability, and/or the like); Prediction of whether the EEC/UE will be in or out of the service area of an EDN/EES after a certain amount of time. The ECS may include the identifier of the EEC/UE in the request and specify the length of the time window; Prediction of what EES(s) may be needed, services needed from the EDN/EESs, or ACs/users' demand/distribution (by ACs/users in the same area as the requesting EEC). This may apply to the scenario where the EEC has not received AC profile or does not include AC profiles in the service provisioning request; Predicted/expected EDN/EES event (e.g., EDN/EES load exceeding a pre-defined threshold, EES maintenance); EDN/EES ranking (in terms of availability, idle resources, reliability, and/or the like); and recommended EDN/EES or EES list (in terms of availability, idle resources, reliability, and/or the like).

Depending on what may be requested in the configuration request, the following non-exhaustive list of operations may be applied to enhance the service provisioning procedure: Based on the predictive EDN/EES status information (e.g., load, availability, number of serving sessions, reliability, and/or the like), the ECS may select the EDN/EESs with better predicted performance (e.g., lower load, higher reliability) and provision their information to the EEC; The ECS may exclude an EDN/EES from the provisioning response if the EEC/UE is predicted to be soon out of the EDN/EES's service area; The ECS may help the EEC select one or more EESs that may be required later by the EEC, or direct the EEC/ACs to EDN/EESs to balance the load of different EDNs/EESs, based on the predicted users' demand/distribution; Based on the predicted/expected EDN/EES event, the ECS may exclude an EDN/EES that is predicted to be overloading or offline/unavailable from the provisioning response; If EDN/EES ranking is provided by the ADAE server, the ECS may include highly ranked EDN/EESs in the provisioning response, and/or include the ranking information in the response; and if EDN/EES recommendation is provided by the ADAE server, the ECS may include the recommended EDN/EES or EES list in the provisioning response.

The method as outlined in the DSP-initiated and DSR-initiated analytics service requests, as shown in FIGS. 2 and 3 respectively, may be applied to a CAPIF Service API discovery method. As indicated in previous table, the DSR may be the API Invoker and the DSP may be the CAPIF Core Function (CCF).

In an analytics-enhanced service API discovery method, the following non-exhaustive list of types of analytics may be requested by the CAPIF core function or API invoker (a “service API” may refer to a certain type/class of service API or a certain instance of service API): Predictive status information (e.g., service level, load, popularity, availability, number of API calls/accesses, reliability, and/or the like) of one or more types/instances of service API; Predicted/expected event related to one or more types/instances of service API (e.g., number of API calls exceeding a pre-defined threshold); Service API ranking (ranked by types/instances, in terms of service level, popularity, availability, reliability, and/or the like); Recommended service API or API list (in terms of service level, popularity, availability, reliability, and/or the like); and predictive discovery of API exposure functionality including AEF, API Invokers, and/or the like. (as entities).

Depending on what has been requested in the configuration request, the following non-exhaustive list of operations may be applied to enhance the service API discovery procedure: Based on the predictive service API status information (e.g., service level, load, availability, number of serving sessions, reliability, and/or the like), the CAPIF core function may select the service APIs with better predicted performance (e.g., lower load, higher reliability) as the discovered APIs; Based on the predicted/expected event, the CAPIF core function may exclude a service API that is predicted to be overloading or offline/unavailable from the discovery response; If service API ranking is provided by the ADAE server, the CAPIF core function may include highly ranked service APIs in the discovery response, and/or include the ranking information in the response; If service API recommendation is provided by the ADAE server, the CAPIF core function may include the Recommended service API or API list in the discovery response; and based on discovery of AEFs new APIs may become available or invocation of already-available APIs may be made more efficient. Based on discovery of API Invokers, additional APIs may be published

The method as outlined in the DSP-initiated and DSR-initiated analytics service requests, as shown in FIGS. 2 and 3 respectively, may be applied to AC information exposure method. As indicated in the previous table, the DSR may be the EAS and the DSP may be the EES.

In analytics-enhanced AC information exposure procedure, the following non-exhaustive list of types of analytics may be requested by the EAS: Predictive AC/EEC/user information (e.g., service requirements, required service KPIs, priority, schedule, expected geographical service area, number of ACs/users, distribution/density, user group, and/or the like); Prediction of what or how many ACs/users may require services from the FAS, what services are required by the ACs/EECs, popularity of the service/application provided by the EAS, or ACs/users' demand/distribution (in the service area of the EAS); Prediction of whether an EEC/UE will be in or out of the service area of the EAS after a certain amount of time. The EES may include the identifier of the EAS in the request and specify the length of the time window; and predicted/expected EEC/AC/user event (e.g., user density exceeding a pre-defined threshold, UE mobility).

Depending on what may be requested in the configuration request, the following non-exhaustive list of operations may be applied to enhance the AC information exposure procedure: Based on the predictive AC/EEC/user information or event, the EES may selectively expose information of a subset of ACs to the EAS, e.g., to balance the workload on different EASs; The EES may exclude an AC from the information exposure response if the AC/UE is predicted to be soon out of the EAS's service area; and by exposing predictive AC information, the EES may help the EAS take proactive actions to optimize service efficiency, e.g., adjusting resource allocation policy or schedule, and/or the like.

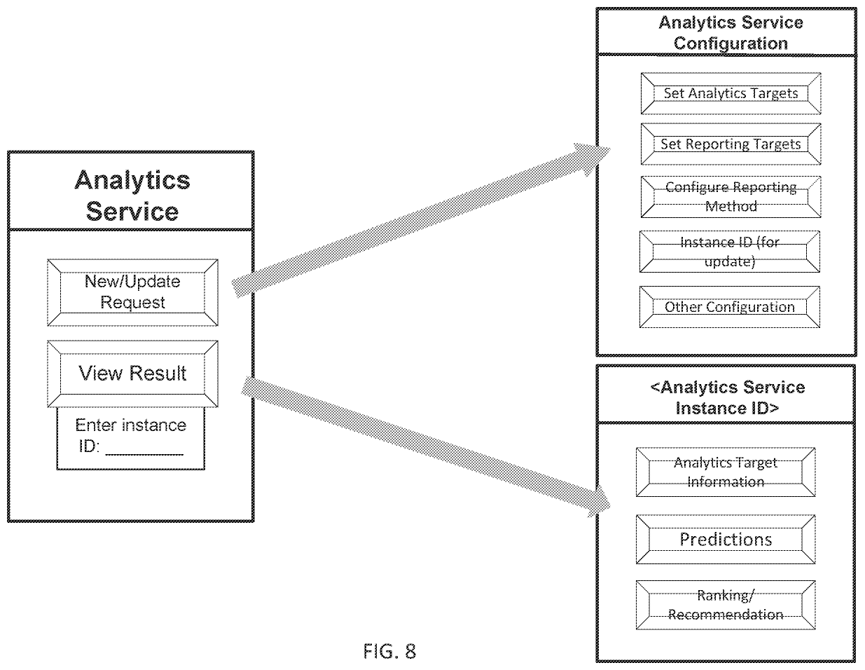

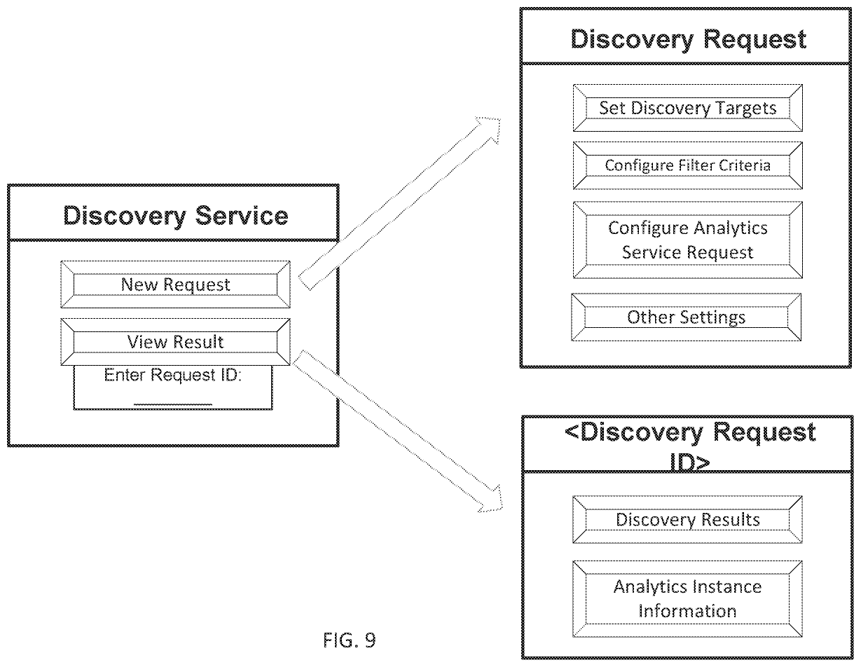

FIGS. 8 and 9 show example Graphical User Interfaces (GUIs). FIG. 8 shows an example GUI for a DSP to configure an analytics service for enhanced discovery in accordance with the methods described herein. FIG. 9 shows an example GUI for a DSR to request an analytics-enhanced discovery service, in accordance with the method described herein.

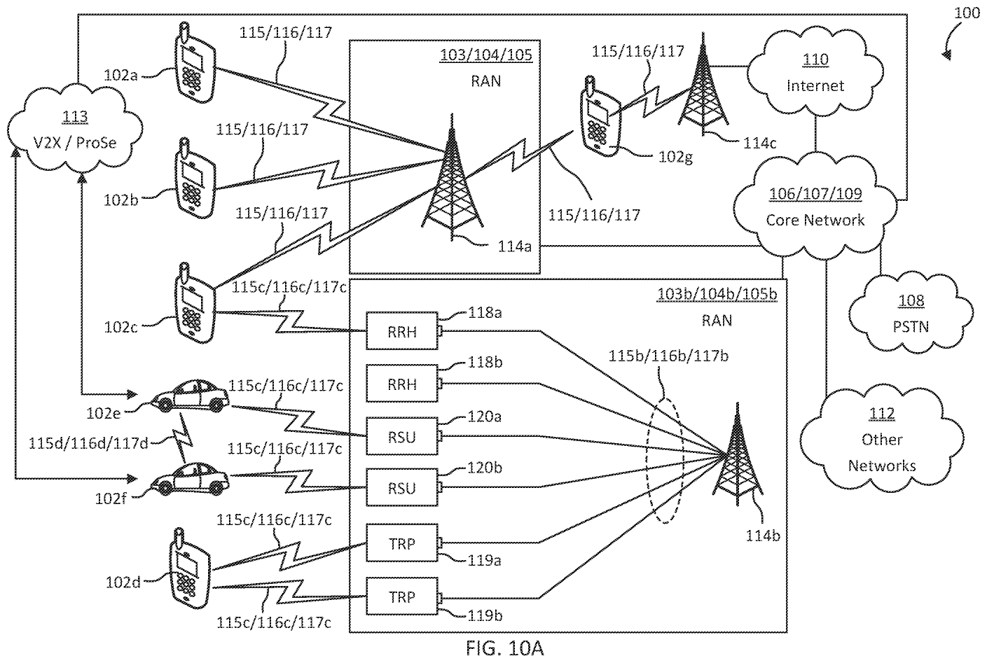

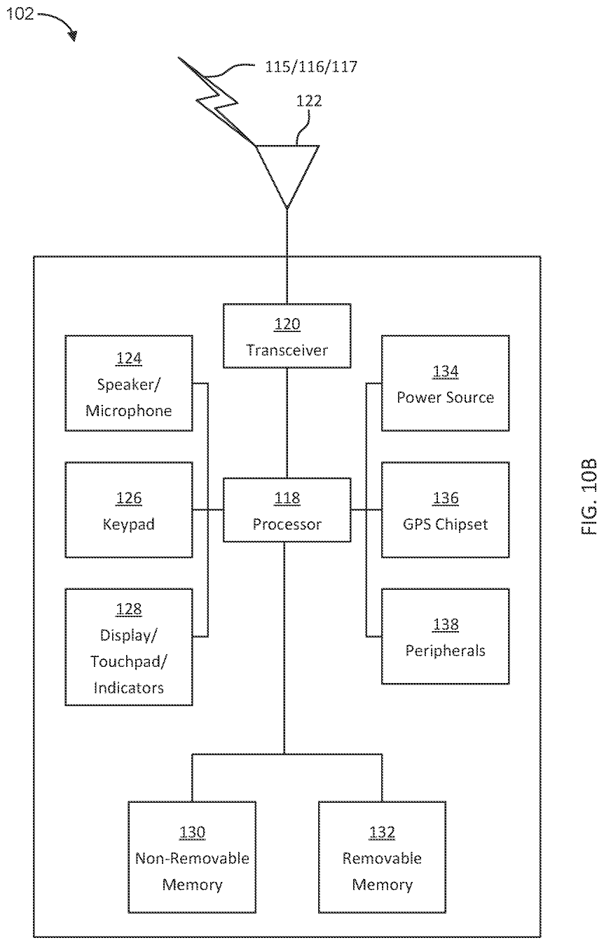

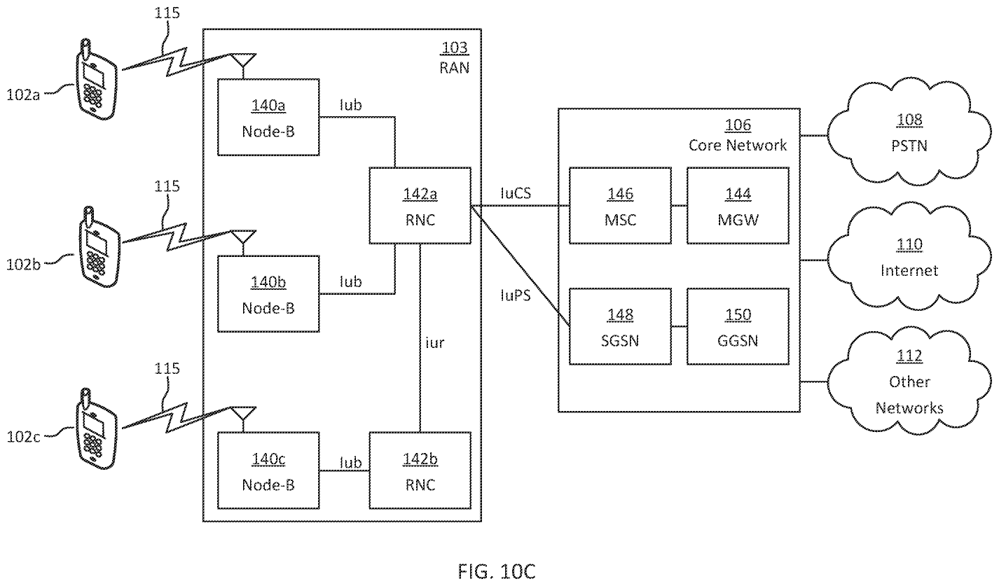

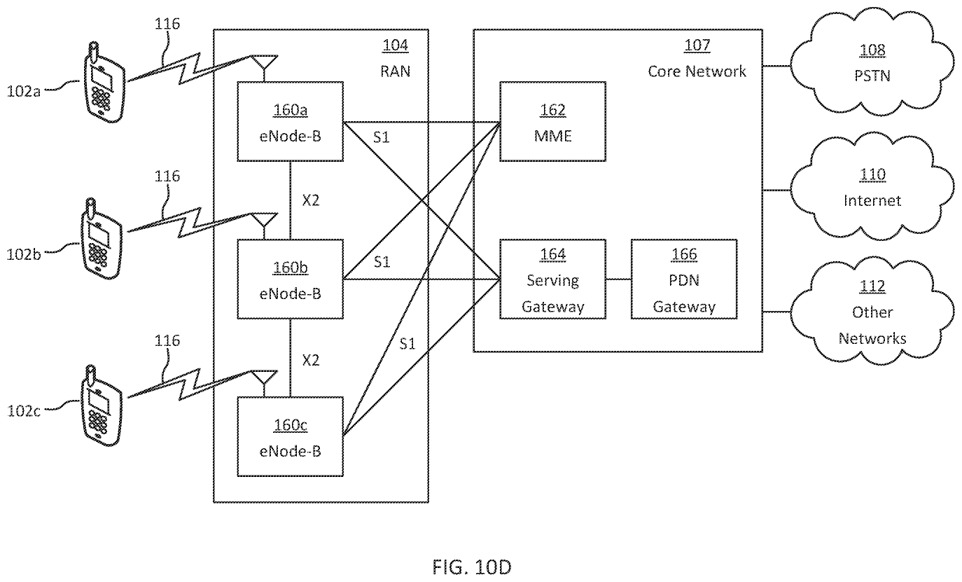

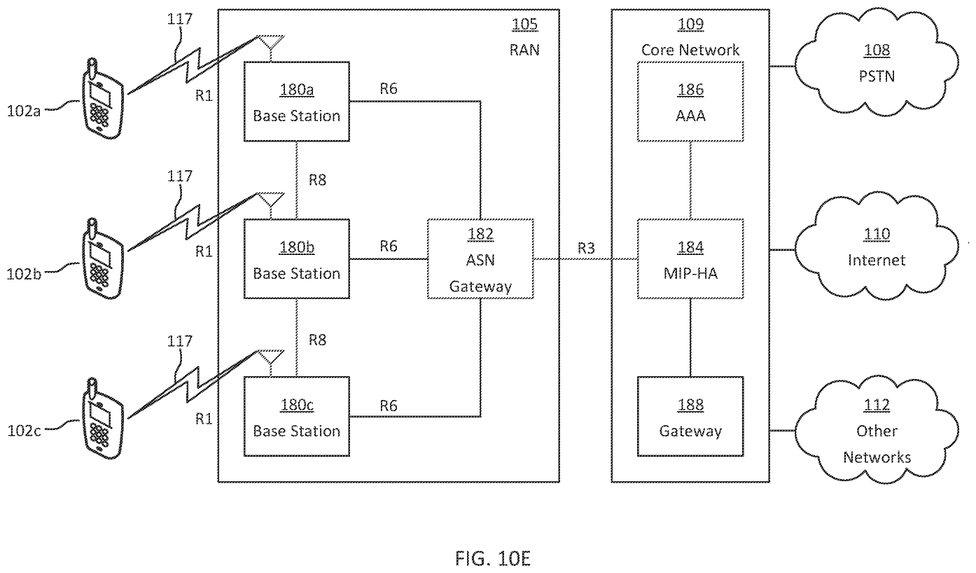

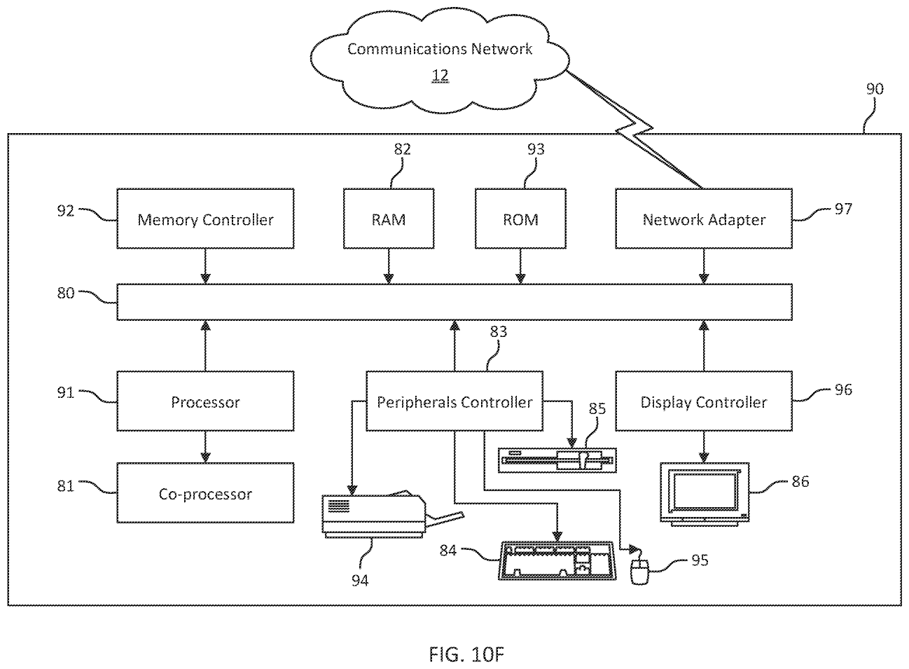

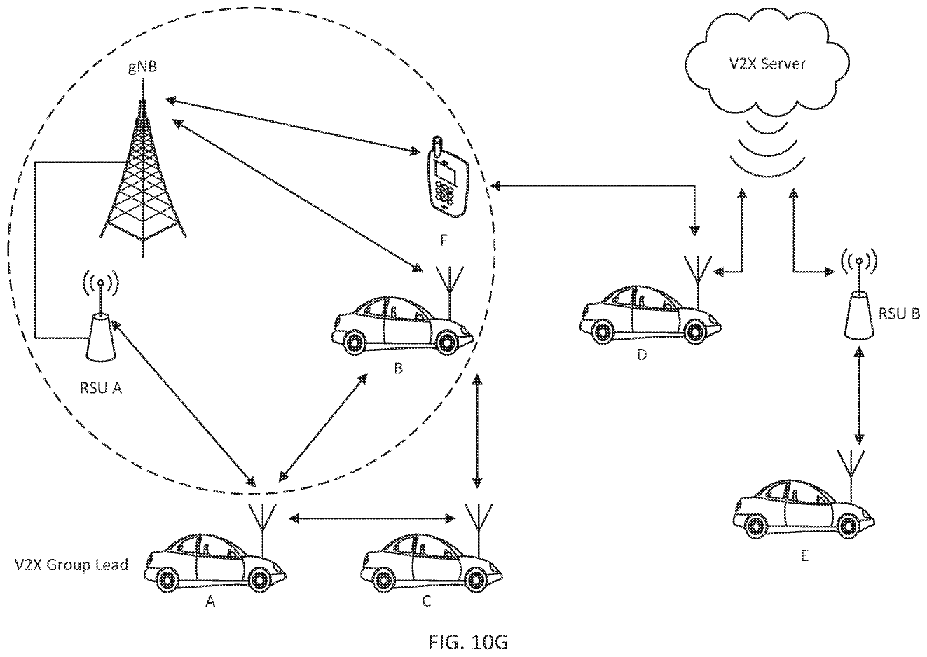

FIG. 10A illustrates an example communications system 100 in which the methods and apparatuses described and claimed herein may be embodied. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 10A-10E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home e Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.).

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 10A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 10A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 10A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 10A may be configured to communicate with the base station 114a, which may employ a cellular-based radio technology, and with the base station 114c, which may employ an IEEE 802 radio technology.

FIG. 10B is a block diagram of an example apparatus or device configured for wireless communications in accordance with the embodiments illustrated herein, such as for example, a WTRU 102. As shown in FIG. 10B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 10B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 10B shows the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 7B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 10C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 7C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 10C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 10C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 10D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 10D, the eNode-Bs 160a, 160b, 160c may communicate with one another over an X2 interface.

The core network 107 shown in FIG. 7D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 10E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 10E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 10E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 10E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 10A, 10C, 10D, and 10E are identified by the names given to those entities in certain existing 3GPP specifications, but it is understood that in the future those entities and functionalities may be identified by other names and certain entities, or functions may be combined in future specifications published by 3GPP, including future 3GPP NR specifications. Thus, the particular network entities and functionalities described and illustrated in FIGS. 10A, 10B, 10C, 10D, and 10E are provided by way of example only, and it is understood that the subject matter disclosed and claimed herein may be embodied or implemented in any similar communication system, whether presently defined or defined in the future.

FIG. 10F is a block diagram of an exemplary computing system 90 in which one or more apparatuses of the communications networks illustrated in FIGS. 10A, 10C, 10D and 10E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 10A, 10B, 10C, 10D, and 10E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 10G illustrates one embodiment of an example communications system 111 in which the methods and apparatuses described and claimed herein may be embodied. As shown, the example communications system 111 may include wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E may be out of range of the network (for example, in the figure out of the cell coverage boundary shown as the dash line). WTRUS A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

What is claimed:

1. A method comprising:
receiving, by an edge enabler server and from a user device, a first message indicating a discovery request for one or more discovery targets, wherein the one or more discovery targets comprise one or more edge application servers;
sending, to an analytics service, a second message indicating a request for analytics information associated with the one or more discovery targets, wherein the analytics information comprises prediction information associated with a future status of the one or more discovery targets;
receiving, from the analytics service, a third message comprising the analytics information associated with the one or more discovery targets;
sending, to the user device and in response to the first message, a fourth message comprising a filtered list of discovery targets based on the analytics information associated with the one or more discovery targets received in the third message.

2. The method of claim 1, wherein the first message further indicates a request for an analytics enhanced discovery service.

3. The method of claim 1, wherein the filtered list ranks the one or more discovery targets based on the prediction information associated with the future status of the one or more discovery targets.

4. The method of claim 1, wherein the fourth message comprises at least a portion of the analytics information received in the third message.

5. The method of claim 1, wherein the fourth message further comprises a recommendation indicating which one or more discovery targets of the filtered list to select.

6. The method of claim 1, wherein the first message further comprises a request for the analytics information associated with the one or more discovery targets.

7. The method of claim 1, wherein the user device comprises a discovery service requestor or another edger enabler server.

8. A method comprising:
sending, by a user device and to an edge enabler server, a first message indicating a discovery request for one or more discovery targets, wherein the one or more discovery targets comprise one or more edge application servers;
receiving, from the edge enabler server, a second message comprising a filtered list of discovery targets based on analytics information associated with the one or more discovery targets, wherein the analytics information comprises prediction information associated with a future status of the one or more discovery targets;
selecting, based on the received filtered list of discovery targets, one or more discovery targets of the one or more discovery targets for a service; and
sending, to the edge enabler server, a third message indicating the one or more discovery targets selected based on the filtered list.

9. The method of claim 8, wherein the edge enabler server received the analytics information from an analytics service.

10. The method of claim 8, wherein the filtered list ranks the one or more discovery targets based on the prediction information associated with the future status of the one or more discovery targets.

11. The method of claim 8, wherein the second message further comprises a recommendation indicating which one or more discovery targets of the filtered list to select.

12. The method of claim 8, wherein the first message further comprises a request for the analytics information associated with the one or more discovery targets.

13. The method of claim 8, wherein the user device comprises a discovery service requestor or another edger enabler server.

14. An edge enabler server comprising one or more processors and memory storing instructions that, when executed by the one or more processors, cause the edge enabler server to perform operations comprising:
receiving, from a user device, a first message indicating a discovery request for one or more discovery targets, wherein the one or more discovery targets comprise one or more edge application servers;
sending, to an analytics service, a second message indicating a request for analytics information associated with the one or more discovery targets, wherein the analytics information comprises prediction information associated with a future status of the one or more discovery targets;
receiving, from the analytics service, a third message comprising the analytics information associated with the one or more discovery targets;
sending, to the user device and in response to the first message, a fourth message comprising a filtered list of discovery targets based on the analytics information associated with the one or more discovery targets received in the third message.

15. The edge enabler server of claim 14, wherein the first message further indicates a request for an analytics enhanced discovery service.

16. The edge enabler server of claim 14, wherein the filtered list ranks the one or more discovery targets based on the prediction information associated with the future status of the one or more discovery targets.

17. The edge enabler server of claim 14, wherein the fourth message comprises at least a portion of the analytics information received in the third message.

18. The edge enabler server of claim 14 wherein the fourth message further comprises a recommendation indicating which one or more discovery targets of the filtered list to select.

19. The edge enabler server of claim 14, wherein the first message further comprises a request for the analytics information associated with the one or more discovery targets.

20. The edge enabler server of claim 14, wherein the user device comprises a discovery service requestor or another edger enabler server.
